(19) United States
(12) Patent Application Publication
(10) Pub. No.: US 2025/0296410 A1
(43) Pub. Date: Sep. 25, 2025

(54) GLASS RUN

(71) Applicant: TOYODA GOSEI CO., LTD., Kiyosu-shi (JP)

(72) Inventors: Yuta Yamato, Kiyosu-shi (JP); Kentaro Adachi, Kiyosu-shi (JP); Kazuya Iwata, Kiyosu-shi (JP)

(21) Appl. No.: 19/048,533

(22) Filed: Feb. 7, 2025

(30) Foreign Application Priority Data
Mar. 22, 2024 (JP) 2024-045983

(51) Int. Cl. B60J 3/02; B60J 10/32; B60J 10/40; B60J 10/76

(52) U.S. Cl. CPC B60J 3/02; B60J 10/40; B60J 10/76; B60J 10/32

(57) ABSTRACT

Provided is a glass run including a bottom wall, a vehicle inner side wall, and a vehicle outer side wall as a basic framework. The framework is attached to a door frame and has an opening that receives a door glass. The glass run includes a vehicle inner sealing lip and a vehicle outer sealing lip that sandwich and seal the vehicle inner and outer sides of the door glass. A vehicle inner cover lip is formed at the distal end of the vehicle inner side wall toward the vehicle inner side and toward a bottom wall, and the vehicle inner cover lip is formed with a shield engagement portion that is engaged with a light shield.

### CROSS REFERENCE TO RELATED APPLICATION

This application claims the priority benefit of Japanese Patent Application No. 2024-045983 filed on Mar. 22, 2024. The entirely of the above-mentioned patent application is hereby incorporated by reference herein and made a part of this application.

### BACKGROUND OF THE INVENTION

### (1) Field of the Invention

The present invention relates to a glass run attached to a door frame formed in a door of a vehicle, such as an automobile, and particularly relates to a glass run that enables attachment of a light shield (this is also referred to as a sunshade, but is hereinafter referred to as a “light shield”).

### (2) Description of Related Art

Some vehicles are provided with light shields, each covering the vehicle inner side of a door glass of a rear side door with a curtain member for the purpose of shading and ensuring privacy. The light shield includes the curtain member movable between a storage position inside the door body and a use position where the vehicle inner side of the door glass is covered.

For example, as shown in FIG. 7, an engagement member 120 for attachment of a light shield 110 is attached to a door frame 100 (for example, Japanese Patent Application Laid-Open No. 2014-227117). The engagement member 120 is attached between the door frame 100 and a glass run 130. The engagement member 120 extends from the vehicle inner side of a vehicle inner side wall 140 of the glass run 130 to the vehicle outer side of a vehicle inner cover lip 150, and protrudes from the distal end portion of the vehicle inner cover lip 150. After protruding, the engagement member 120 extends toward the vehicle bottom in an upwardly convex arc shape, then forming a substantially J-shape with a downwardly convex arc.

On the other hand, the upper edge of the light shield 110 is provided with a flat plate-shaped support member 160 elongated in the vehicle front-rear direction along the upper edge. A plurality of engagement holes 170 are formed in the support member 160 at appropriate intervals in the vehicle front-rear direction. The engagement hole 170 is configured to be engageable with the engagement member 120.

An occupant holds and pulls out the support member 160 of the light shield 110, thereby pulling the light shield 110 upward. Then, the engagement hole 170 formed in the support member 160 of the light shield 110 is engaged with the engagement member 120, whereby the light shield 110 is held in a state of covering the vehicle inner side of the door glass 180.

### SUMMARY OF THE INVENTION

Meanwhile, in the structure of FIG. 7, first, in a state where the engagement member 120 and the engagement hole 170 of the light shield 110 are engaged, the light shield 110 is located on the vehicle inner side relative to the glass run 130, thus narrowing the inner space of the vehicle. Accordingly, the occupant may feel pressure on the vehicle inner side.

Second, to engage the engagement member 120 with the engagement hole 170 of the light shield 110, the occupant needs to once pull the support member 160 of the light shield 110 upward above the engagement member 120 and then engage the engagement member 120 with the engagement hole 170 of the light shield 110. To release the engagement, the support member 160 of the light shield 110 needs to be pulled upward above the engagement member 120 and pulled toward the vehicle inner side. This may cause the occupant to feel that attaching and detaching the light shield 110 is burdensome.

Third, if the occupant erroneously pulls the light shield 110 downward while the engagement member 120 and the engagement hole 170 of the light shield 110 are engaged, the engagement hole 170 of the light shield 110 may be damaged or, if not damaged, the engagement member 120 may be deformed. In particular, if the distal end portion of the engagement member 120 is deformed toward the vehicle inner side and downward, the distal end portion of the engagement member 120 may face the direction of the occupant and hit the occupant, which may cause a problem in terms of safety. In addition, if the engagement is performed again while the distal end portion of the engagement member 120 is deformed, the reliability of the engagement between the engagement member 120 and the engagement hole 170 of the light shield 110 may be reduced. Also, time is required to attach the light shield 110 to the engagement member 120. Moreover, when the deformed engagement member 120 is replaced, the glass run 130 needs to be removed from the door frame 100.

The present invention relates to a glass run attached to a door frame formed in a door of a vehicle, such as an automobile, and particularly to a glass run that enables a light shield to be attached safely and easily while suppressing the narrowing of the vehicle inner space.

To solve the above problem, a first aspect of the present invention is a glass run attached to a door frame of a door of a vehicle, the glass run including: a bottom wall; a vehicle inner side wall and a vehicle outer side wall that extend from the bottom wall; a vehicle inner sealing lip connected to the vehicle inner side wall; and a vehicle outer sealing lip connected to the vehicle outer side wall. The glass run guides lifting and lowering of a door glass. A vehicle inner cover lip is formed at a distal end of the vehicle inner side wall toward a vehicle inner side and toward a bottom wall, and the vehicle inner cover lip is formed with a shield engagement portion that is engaged with a light shield.

In the first aspect of the present invention, a vehicle inner cover lip is formed at the distal end of the vehicle inner side wall toward the vehicle inner side and toward the bottom wall, and the vehicle inner cover lip is formed with a shield engagement portion that is engaged with the light shield. Therefore, by engaging the light shield with the shield engagement portion of the vehicle inner cover lip of the glass run, the position of the light shield can be moved to the door glass side. As a result, it is possible to expand the vehicle inner space when the light shield is used. It is also possible to reduce the sense of pressure inside the vehicle for an occupant.

A second aspect of the present invention is the glass run according to the first aspect, in which a magnet is used for the engagement between the shield engagement portion and the light shield, and the shield engagement portion includes the magnet or a ferromagnetic material attracted to the magnet.

In the second aspect of the present invention, a magnet is used for the engagement between the shield engagement portion and the light shield, and the shield engagement portion includes the magnet or a ferromagnetic material attracted to the magnet. Therefore, the shield engagement portion formed on the cover lip of the glass run can be easily engaged with the light shield. As a result, the burdensome nature of engagement between the shield engagement portion and the light shield can be greatly suppressed.

In addition, since the ferromagnetic material or the magnet can form the shield engagement portion by being stuck to the cover lip of the glass run, the shield engagement portion can be easily formed even when the shield engagement portion is not formed during the extrusion molding of the glass run.

A third aspect of the present invention is the glass run according to the second aspect, in which the shield engagement portion includes the ferromagnetic material, and the ferromagnetic material is formed on the vehicle inner side surface of the vehicle inner cover lip or is formed by being embedded inside the vehicle inner cover lip.

In the third aspect of the present invention, the shield engagement portion includes the ferromagnetic material, and the ferromagnetic material is formed on the vehicle inner side surface of the vehicle inner cover lip or is formed by being embedded inside the vehicle inner cover lip. Therefore, during the manufacturing of the glass run, a plate-like member containing a ferromagnetic material, such as iron or nickel, is coextruded with the material of the glass run as an insert, enabling the shield engagement portion to be formed on the vehicle inner side surface of the vehicle inner cover lip or formed by being embedded inside the vehicle inner cover lip.

A fourth aspect of the present invention is the glass run according to the first aspect, in which the shield engagement portion is each of recesses having openings or holes disposed at an interval in a longitudinal direction of a vehicle inner side surface of the vehicle inner cover lip.

In the fourth aspect of the present invention, the shield engagement portions are recesses having openings or holes disposed at an interval in the longitudinal direction of the vehicle inner side surface of the vehicle inner cover lip. Therefore, the shield engagement portion and the light shield can be easily and reliably engaged by forming a protrusion connectable to the recess or the hole on the light shield side.

A fifth aspect of the present invention is the glass run according to the first aspect, in which the shield engagement portion is each of recesses formed continuously in a longitudinal direction of a vehicle inner side surface of the vehicle inner cover lip.

In the fifth aspect of the present invention, the shield engagement portions are recesses formed continuously in the longitudinal direction of the vehicle inner side surface of the vehicle inner cover lip. Therefore, for example, when the light shield has the shape of a curtain that opens horizontally, the curtain can be easily and smoothly opened and closed by attaching a runner (curtain runner) to the recess.

### BRIEF DESCRIPTION OF THE DRAWINGS

FIG. 1 is a front view of a sliding door of an automobile.

FIG. 2 is a front view showing a glass run used for the door frame of FIG. 1.

FIG. 3 is a cross-sectional view taken along line A-A in FIG. 1.

FIG. 4 is a glass run according to a first embodiment of the present invention, and is an enlarged cross-sectional view of a region B in FIG. 3.

FIG. 5 is a glass run according to a second embodiment of the present invention, and is an enlarged cross-sectional view of the region B in FIG. 3.

FIG. 6 is a glass run according to a third embodiment of the present invention, and is an enlarged cross-sectional view of the region B in FIG. 3.

FIG. 7 is a cross-sectional view showing a conventional glass run, and is a cross-sectional view corresponding to line A-A in FIG. 1 (Japanese Patent Application Laid-Open No. 2014-227117).

### SUMMARY OF THE INVENTION

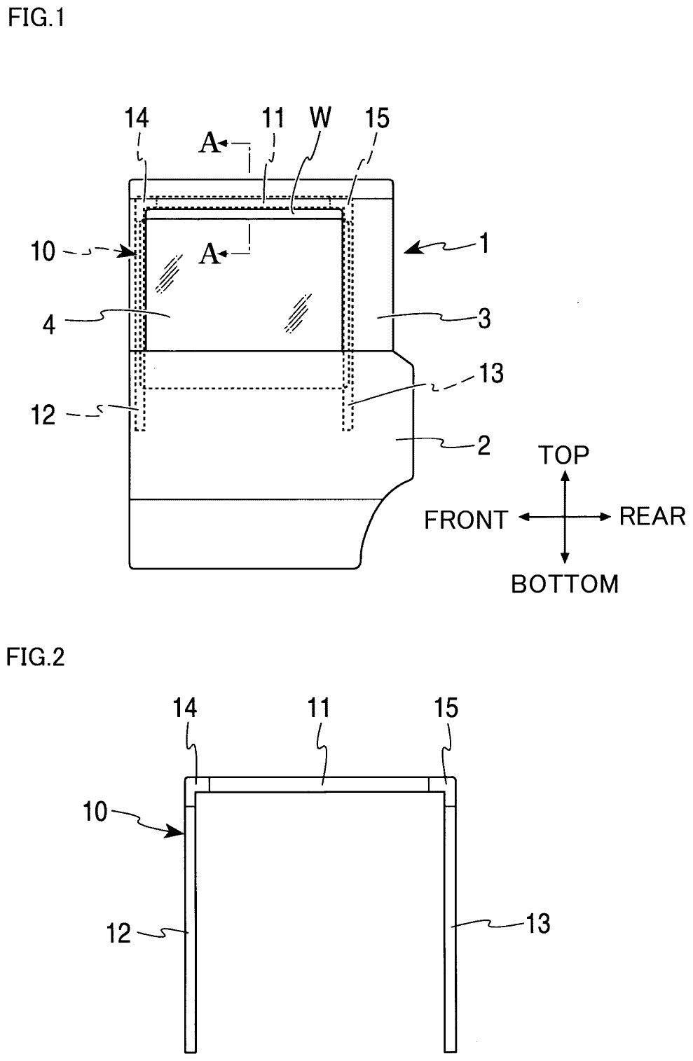

FIG. 1 is a diagram showing a schematic configuration of a left rear sliding door 1 (hereinafter abbreviated as “sliding door 1”) of an automobile to which a glass run 10 is attached. In FIG. 1, the left side corresponds to the front side (front side) and the right side corresponds to the rear side (rear side) in the drawing.

As shown in FIG. 1, a door frame 3 is integrally formed in a sliding door 1 above a door body 2. Also, a glass run 10 is attached to the door frame 3. The glass run 10 guides lifting and lowering of door glass 4, and seals between the peripheral edge of the door glass 4 and the door frame 3 when a door glass opening W is closed by lifting the door glass 4. Note that the present invention is applicable not only to the left rear sliding door but also to the right rear sliding door and the left and right rear doors.

FIG. 2 is a simplified front view of the glass run 10 attached to the door frame 3 of FIG. 1, as viewed from the vehicle outer side. The glass run 10 includes a first extrusion-molded portion 11 corresponding to the horizontal frame portion of the door frame 3, a second extrusion-molded portion 12 corresponding to the front vertical frame portion of the sliding door 1, and a third extrusion-molded portion 13 corresponding to the rear vertical frame portion. The front end of the first extrusion-molded portion 11 is connected to the upper end of the second extrusion-molded portion 12 by a first die-molded portion 14. The rear end of the first extrusion-molded portion 11 is connected to the upper end of the third extrusion-molded portion 13 by a second die-molded portion 15.

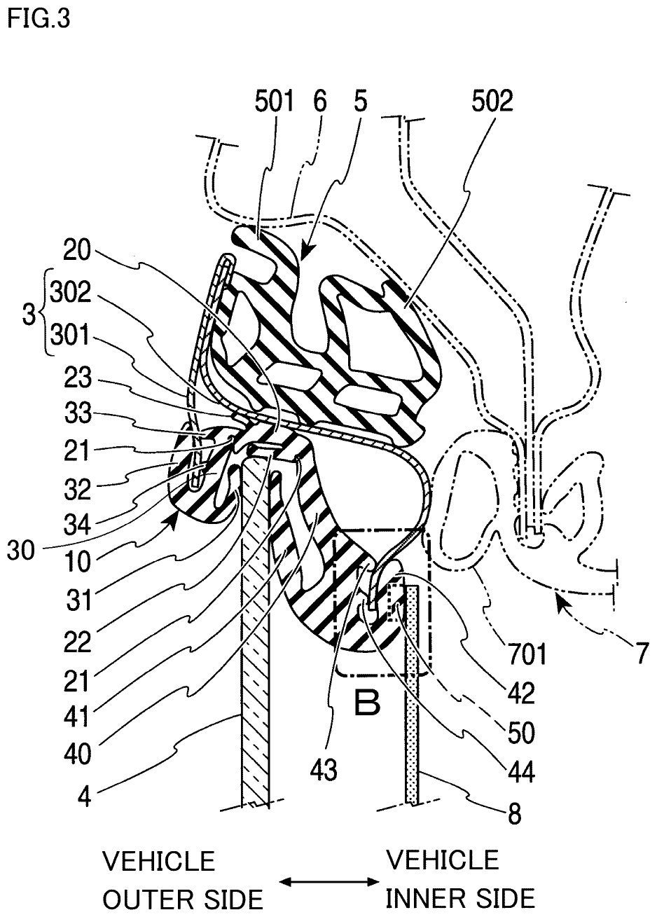

FIG. 3 is a cross-sectional view corresponding to line A-A in FIG. 1, and is a cross-sectional view of the first extrusion-molded portion 11 in the glass run 10. The cross section of the glass run 10 is uniformly formed in the first extrusion-molded portion 11. In FIG. 3, the door frame 3, to which the glass run 10 is attached, includes an outer frame 301 located on the vehicle outer side and an inner frame 302 located on the vehicle inner side. These frames are integrated on the upper side by hemming such that the outer frame 301 overlaps the inner frame 302 on the upper side of the door frame. In FIG. 3, a part of the cross section on the vehicle body side is also indicated by a broken line.

A door weather strip 5 is attached above the inner frame 302 located above the glass run 10. When the sliding door 1 is closed, a lip portion 501 and a hollow sealing portion 502 of the door weather strip 5 elastically contact a vehicle body opening peripheral edge 6 to close the gap between the sliding door 1 and the vehicle body opening peripheral edge 6.

An opening trim weather strip 7 is attached to a distal end portion on the vehicle inner side of the peripheral edge of the vehicle body opening. When the sliding door 1 is closed, a hollow sealing portion 701 of the opening trim weather strip 7 elastically contacts the vehicle inner side of the inner frame 302 of the sliding door 1.

The glass run 10 includes a basic framework of a bottom wall 20, a vehicle outer side wall 30, and a vehicle inner side wall 40 as a basic framework, and is formed in a channel shape (a substantially U-shaped in cross section). The connecting portions between the bottom wall 20, the vehicle outer side wall 30, and the vehicle inner side wall 40 are connected in a freely deployable manner by grooves 21, 21 on the vehicle outer side and the vehicle inner side. The vehicle inner side wall 40 is formed larger than the vehicle outer side wall 30, and the shapes of these side walls are asymmetrical, with the vehicle inner side being larger.

The bottom wall 20 is formed in a substantially plate shape, a door glass side lip 22 is formed on the door glass 4 side of the bottom wall 20, and a frame side lip 23 is formed on the inner frame 302 side of the bottom wall 20.

A vehicle outer sealing lip 31 extending in the direction of the bottom wall 20 is formed on the vehicle inner side of the distal end portion of the vehicle outer side wall 30.

A vehicle outer cover lip 32 extending in the direction of the bottom wall 20 is formed on the vehicle outer side wall of the distal end portion of the vehicle outer side wall 30. In addition, in the vicinity of the connecting portion with the bottom wall 20, a vehicle outer holding lip 33 is formed on the vehicle outer side wall and in the direction of the distal end portion of the vehicle outer side wall 30, and a vehicle outer holding rib 34 protruding to the vehicle outer side wall is formed between the vehicle outer holding lip 33 and the vehicle outer cover lip 32.

The outer frame 301 of the door frame 3 is inserted between the vehicle outer side wall 30 and the vehicle outer cover lip 32, and is held by the vehicle outer side surface of the vehicle outer side wall 30, the vehicle inner side surface of the vehicle outer cover lip 32, the vehicle outer holding lip 33, and the vehicle outer holding rib 34.

A vehicle inner sealing lip 41 extending in the direction of the bottom wall 20 is formed on the vehicle outer side of the distal end portion of the vehicle inner side wall 40.

A vehicle inner cover lip 42 extending in the direction of the bottom wall 20 is formed on the vehicle inner side of the distal end portion of the vehicle inner side wall 40. In addition, a vehicle inner side holding lip 43 and a vehicle inner side holding rib 44 are formed on the vehicle inner side of the vehicle inner side wall 40 closer to the bottom wall 20 than the vehicle inner cover lip 42.

The inner frame 302 of the door frame 3 is inserted between the vehicle inner side wall 40 and the vehicle inner cover lip 42, and is held by the vehicle outer side surface of the vehicle inner cover lip 42, the vehicle inner side holding lip 43, and the vehicle inner side holding rib 44.

When the glass run 10 is attached to the outer frame 301 and the inner frame 302 of the door frame 3, the bottom wall 20 and the frame side lip 23 elastically contact the inner frame 302 on the bottom wall 20 of the glass run 10.

The door glass 4 is inserted between the vehicle outer sealing lip 31 and the vehicle inner sealing lip 41, and the vehicle outer sealing lip 31 and the vehicle inner sealing lip 41 elastically contact each other to seal the vehicle inner and outer surfaces of the door glass 4. In a state where the door glass 4 is fully closed, the door glass side lip 22 of the bottom wall 20 elastically contacts the door glass 4.

In the embodiment of the present invention, a material constituting the glass run 10 can be formed of rubber, a thermoplastic elastomer, a soft synthetic resin, or the like. For the rubber, ethylene propylene diene rubber (EPDM) is desirable, and for the thermoplastic elastomer, olefinic thermoplastic elastomer (TPO) or dynamically crosslinked thermoplastic elastomer (TPV) is desirable from the viewpoint of weather resistance, recycling, cost, and the like.

A shield engagement portion 50 engageable with a light shield 8 is formed on the vehicle inner cover lip 42. The engagement between the shield engagement portion 50 and the light shield 8 will be described in detail in the following first to third embodiments.

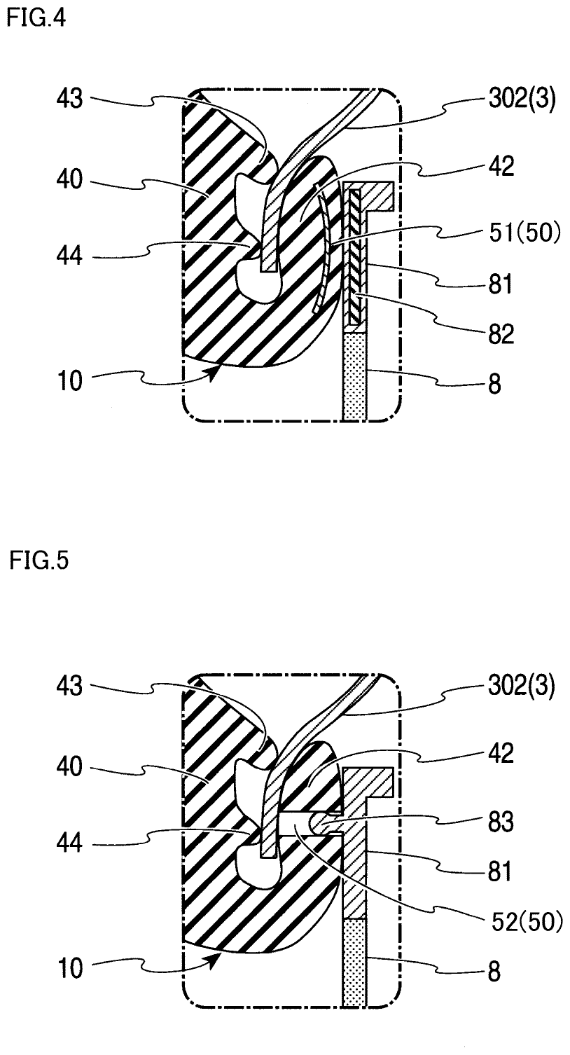

FIG. 4 is a glass run 10 according to the first embodiment of the present invention, and is an enlarged cross-sectional view of a region B in FIG. 3. A ferromagnetic steel plate 51 is embedded in the vehicle inner cover lip 42. That is, in the first embodiment, the shield engagement portion 50 is a steel plate 51. The steel plate 51 is coextruded as an insert during the extrusion of the glass run 10.

Although not shown, the light shield 8 is configured in a sheet shape to be wound in a pullable manner and stored by a winding drum provided inside a door trim disposed on the vehicle inner side of the door body 2 of the sliding door 1. A support 81 is attached to the upper edge of the light shield 8. The support 81 has a flat plate shape elongated in the vehicle front-rear direction. A magnet 82 is attached to the support 81.

The occupant holds and pulls up the support 81 of the light shield 8, thereby pulling the light shield 8 upward. Then, when the support 81 is pulled up to the vicinity of the vehicle inner cover lip 42 of the glass run 10, the magnet 82 of the support 81 and the steel plate 51 in the vehicle inner cover lip 42 are attracted and engaged, and the support 81 of the light shield 8 can be held by the vehicle inner cover lip 42. Note that a magnet may be used for the shield engagement portion 50 instead of the steel plate 51, and if a magnet is used for the shield engagement portion 50, a steel plate may be used instead of the magnet 82 of the support 81.

Next, a second embodiment of the present invention will be described with reference to FIG. 5. FIG. 5 is a glass run 10 according to a second embodiment of the present invention, and is an enlarged cross-sectional view of the region B in FIG. 3. In the vehicle inner cover lip 42, a plurality of holes 52, which are cylindrical through holes, are formed at intervals in the longitudinal direction of the vehicle inner cover lip 42. That is, in the second embodiment, the shield engagement portion 50 is the hole 52. The hole 52 was formed by laser processing after the glass run 10 was extruded. Note that the shield engagement portion 50 may be a recess that does not penetrate the vehicle inner cover lip 42. The hole 52 and the recess may be formed by drilling as well as laser processing.

On the other hand, the support 81 of the light shield 8 is formed with a protrusion 83 protruding to the position of the hole 52 formed in the vehicle inner cover lip 42. The protrusion 83 has a shape in which a ball is connected to a distal end of a cylinder protruding from the support 81. The diameter of the sphere of the protrusion 83 is designed to be slightly larger than the diameter of the hole 52.

The occupant holds and pulls up the support 81 of the light shield 8, thereby pulling the light shield 8 upward. Then, by inserting the protrusion 83 of the support 81 into the hole 52 of the vehicle inner cover lip 42 of the glass run 10 and engaging the protrusion 83 with the hole 52, the light shield 8 can be held by the vehicle inner cover lip 42.

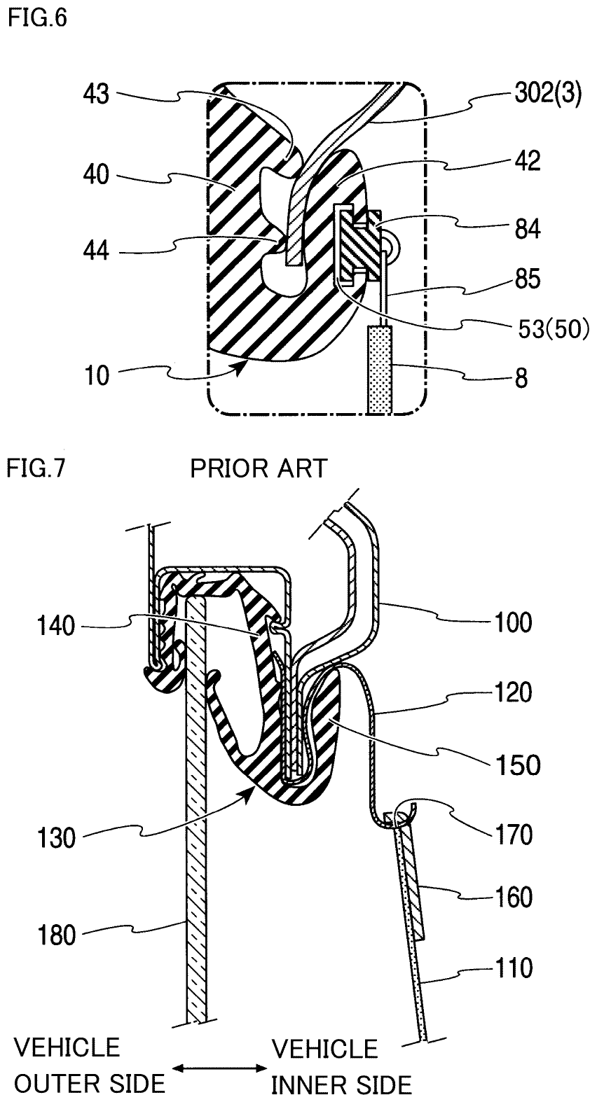

Next, a third embodiment of the present invention will be described with reference to FIG. 6. FIG. 6 is a glass run 10 according to a third embodiment of the present invention, and is an enlarged cross-sectional view of the region B in FIG. 3. The vehicle inner cover lip 42 is formed with a recess 53 that is narrow on the vehicle inner side and wide in the vertical direction. The recess 53 is continuously formed in the longitudinal direction during the extrusion of the glass run 10. That is, in the third embodiment, the shield engagement portion 50 is the recess 53 formed continuously in the longitudinal direction.

On the other hand, unlike the first and second embodiments, the light shield 8 has the shape of a curtain that opens horizontally. A runner 84 is attached to a runner attachment portion 85 of the curtain-shaped light shield 8. By attaching the runner 84 to the recess 53, the runner 84 moves in the vehicle front-rear direction in the recess 53, and the light shield 8 can be opened and closed. That is, the recess 53 has a function of a curtain rail. When the light shield 8 is not in use, the light shield 8 may be moved in one of the front or rear directions of the vehicle and bundled with a tassel held by a hook (not shown).

As described above in detail above, according to the present embodiment, the following effects can be obtained.
(1) In the present embodiment, the vehicle inner cover lip 42 is formed at the distal end portion of the vehicle inner side wall 40 toward the vehicle inner side and the bottom wall direction, and the vehicle inner cover lip 42 is formed with the shield engagement portion 50 that is engaged with the support 81 of the light shield 8. Therefore, by engaging the light shield 8 with the shield engagement portion 50 of the vehicle inner cover lip 42 of the glass run 10, the position of the light shield 8 can be moved to the door glass side. As a result, it is possible to expand the vehicle inner space when the light shield 8 is used. It is also possible to reduce the sense of pressure inside the vehicle for an occupant.
(2) In the present embodiment, for the shield engagement portion 50, the ferromagnetic steel plate 51 is embedded as an insert in the vehicle inner cover lip 42, and the support 81 is attached to the upper edge of the light shield 8. The magnet 82 is attached to the support 81, and the occupant pulls up the support 81 of the light shield 8, whereby the light shield 8 is pulled upward, and the magnet 82 of the support 81 and the steel plate 51 of the vehicle inner cover lip 42 are attracted and engaged, enabling the support 81 of the light shield 8 to be held by the vehicle inner cover lip 42. Therefore, the shield engagement portion 50 and the light shield 8 can be easily engaged, and the engagement can be easily released. As a result, in addition to the effect of (1) described above, the burdensome nature during engagement between the shield engagement portion 50 and the light shield 8, as well as during the release of the engagement, can be greatly suppressed. Further, since the ferromagnetic steel plate 51 as the shield engagement portion 50 is embedded in the vehicle inner cover lip 42, generation of rust on the surface can be suppressed. In addition, the engagement with the light shield 8 is performed by attaching and detaching the magnet 82 and the shield engagement portion 50, which is a ferromagnetic material, thereby ensuring the safety.
(3) In the present embodiment, the plurality of columnar holes 52 are formed as the shield engagement portions 50 in the vehicle inner cover lip 42 at intervals in the longitudinal direction of the vehicle inner cover lip 42, and the protrusion 83 protruding to the position of the hole 52 formed in the vehicle inner cover lip 42 is formed in the support 81 of the light shield 8. The occupant holds and pulls up the support 81 of the light shield 8, thereby pulling the light shield 8 upward. The projecting protrusion 83 of the support 81 is inserted into the hole 52 of the vehicle inner cover lip 42 of the glass run 10, and the projecting protrusion 83 and the hole 52 are engaged, enabling the light shield 8 to be held by the vehicle inner cover lip 42. Therefore, in addition to the effect of (1) described above, the shield engagement portion 50 and the light shield 8 can be easily and reliably engaged. Even if the occupant erroneously pulls the light shield 8 downward while the hole 52 and the protrusion 83 are engaged, the protrusion 83 only comes out of the hole 52, thereby ensuring the safety.
(4) In the present embodiment, in the vehicle inner cover lip 42, as the shield engagement portion 50, the recess 53, which is narrow on the vehicle inner side and wide in the vertical direction, is continuously formed in the longitudinal direction, and the runner 84 is attached to the runner attachment portion 85 of the light shield 8 having the shape of a curtain that opens horizontally. By attaching the runner 84 to the recess 53, the light shield 8 can be opened and closed. Therefore, in addition to the effect of the above (1), the curtain-shaped light shield 8 can be opened and closed easily and smoothly. Even if the occupant erroneously pulls the light shield 8 downward while the recess 53 and the runner 84 are engaged, the runner 84 is only detached from the recess 53, or the runner 84 and the runner attachment portion 85 are only disconnected from each other, thereby ensuring the safety.

Implementing the embodiment is not limited to the above embodiments, and various modifications can be made without departing from the object of the present invention.

For example, in the first embodiment described above, the ferromagnetic steel plate 51 is embedded in the vehicle inner cover lip 42 by being co-extruded as an insert during the extrusion molding of the glass run 10. However, the steel plate 51 may be formed to be exposed to the vehicle inner side surface of the vehicle inner cover lip 42. In addition, the material is not limited to a steel plate as long as a ferromagnetic material is used.

For example, in the third embodiment described above, the recess 53, which serves as the shield engagement portion 50, has a cross-sectional shape that is narrow on the vehicle inner side and wide in the vertical direction to match the runner 84. However, the recess 53 may be shaped to match the attachment portion of the curtain-shaped light shield 8. For example, if the cross-section of the attachment portion of the light shield 8 is key-shaped, the recess 53, which serves as the shield engagement portion 50, may also be shaped to match the key shape of the attachment portion.

What is claimed is:

1. A glass run attached to a door frame of a door of a vehicle, the glass run comprising:
a bottom wall;
a vehicle inner side wall and a vehicle outer side wall that extend from the bottom wall;
a vehicle inner sealing lip connected to the vehicle inner side wall; and
a vehicle outer sealing lip connected to the vehicle outer side wall,
the glass run guiding lifting and lowering of a door glass, wherein
a vehicle inner cover lip is formed at a distal end of the vehicle inner side wall toward a vehicle inner side and toward a bottom wall, and
the vehicle inner cover lip is formed with a shield engagement portion that is engaged with a light shield.

2. The glass run according to claim 1, wherein a magnet is used for the engagement between the shield engagement portion and the light shield, and the shield engagement portion includes the magnet or a ferromagnetic material attracted to the magnet.

3. The glass run according to claim 2, wherein the shield engagement portion includes the ferromagnetic material, and the ferromagnetic material is formed on a vehicle inner side surface of the vehicle inner cover lip or is formed by being embedded inside the vehicle inner cover lip.

4. The glass run according to claim 1, wherein the shield engagement portion is each of recesses having openings or holes disposed at an interval in a longitudinal direction of a vehicle inner side surface of the vehicle inner cover lip.

5. The glass run according to claim 1, wherein the shield engagement portion is each of recesses formed continuously in a longitudinal direction of a vehicle inner side surface of the vehicle inner cover lip.
